(19) United States
(12) Patent Application Publication
(10) Pub. No.: US 2018/0311706 A1
(43) Pub. Date: Nov. 1, 2018

(54) STEAM-GENERATING DEVICE AND STEAM-CLEANING APPARATUS

(71) Applicant: Protrend Co., Ltd., Taipei City (TW)

(72) Inventor: Shun-Yi Chen, Taipei City (TW)

(21) Appl. No.: 15/963,140

(22) Filed: Apr. 26, 2018

(30) Foreign Application Priority Data
Apr. 28, 2017 (TW) 106114336

(51) Int. Cl. B08B 3/10

(52) U.S. Cl. CPC B08B 3/106

(57) ABSTRACT

A steam-generating device includes a liquid storage unit and a combustion unit. The combustion unit is connected with the liquid storage unit. The combustion unit transfers a heat generated by burning a fuel to the liquid inside the liquid storage unit so as to heat up the liquid in the liquid storage unit and then generate a steam. In addition, a steam cleaning apparatus adopting the steam-generating device is also provided.

This application claims the benefit of Taiwan Patent Application Serial No. 106114336, filed Apr. 28, 2017, the subject matter of which is incorporated herein by reference.

### BACKGROUND OF THE INVENTION

### (1) Field of the Invention

The invention relates to a generation device and a clean apparatus, and more particularly to a steam-generating device and a steam-cleaning apparatus.

### (2) Description of the Prior Art

The steam cleaner is a machine that utilizes a high-temperature steam to clean floors, windows, clothes, kitchen ventilators, air conditioners and so on, in order to kill or remove surface germs and/or various bacteria, microorganisms and/or pathogens attaching on the body. Thereupon, stains on or attaching the object can be removed, without using the harmful chemicals, damaging the objects and polluting secondarily the environment.

Currently, in the marketplace, the steam cleaner usually adopts electricity to provide heat source. Hence, an electric cable is necessary. However, to some degree, the electric cable might degrade the usage comfort. Thus, an improvement upon the conventional steam cleaner to overcome o remove the discomfort caused by the electric cable is definitely welcome to the art.

### SUMMARY OF THE INVENTION

Accordingly, it is an object of the present invention to provide a steam-generating device that can produce steams by a combustion heat source to replace the conventional electric heat source.

It is another object of the present invention to provide a steam-cleaning apparatus that applies the aforesaid steam-generating device to produce steams for cleaning.

In the present invention, the steam-cleaning apparatus includes a housing unit and a steam-generating device. The steam-generating device includes a liquid storage unit and a combustion unit. The liquid storage unit, located inside the housing unit, further includes a water storage chamber, a water inlet and a steam outlet. The water inlet is connected spatially with the water storage chamber, and the steam outlet is connected spatially with the water storage chamber. The water inlet is to introduce a liquid into the water storage chamber. The combustion unit, located in the housing unit, is connected with the liquid storage unit. The combustion unit transfers a heat generated by burning a fuel to the liquid inside the liquid storage unit so as to heat up the liquid in the liquid storage unit and then generate a steam outputted by the steam outlet.

In another aspect of the present invention, the steam-generating device includes a liquid storage unit and a combustion unit. The combustion unit is connected with the liquid storage unit. The combustion unit transfers a heat generated by burning a fuel to the liquid inside the liquid storage unit so as to heat up the liquid in the liquid storage unit and then generate a steam.

As stated, in the steam-generating device and the steam-cleaning apparatus of the present invention, the steam-generating device provides a combustion way to produce the steams, such that the conventional electric heat source can be replaced. By providing the aforesaid steam-generating device to the steam-cleaning apparatus, thus no electric cable is needed anymore for the steam-cleaning apparatus. Namely, a wireless steam-cleaning apparatus is obtained.

All these objects are achieved by the steam-generating device and the steam-cleaning apparatus described below.

### BRIEF DESCRIPTION OF THE DRAWINGS

The present invention will now be specified with reference to its preferred embodiment illustrated in the drawings, in which:

FIG. 1 is a schematic view of an embodiment of the steam-generating device in accordance with the present invention;

FIG. 2 is a schematic view of an embodiment of the steam-cleaning apparatus in accordance with the present invention; and

FIG. 3 is a schematic view of another embodiment of the steam-cleaning apparatus in accordance with the present invention.

### DESCRIPTION OF THE PREFERRED EMBODIMENT

The invention disclosed herein is directed to a steam-generating device and a steam-cleaning apparatus. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

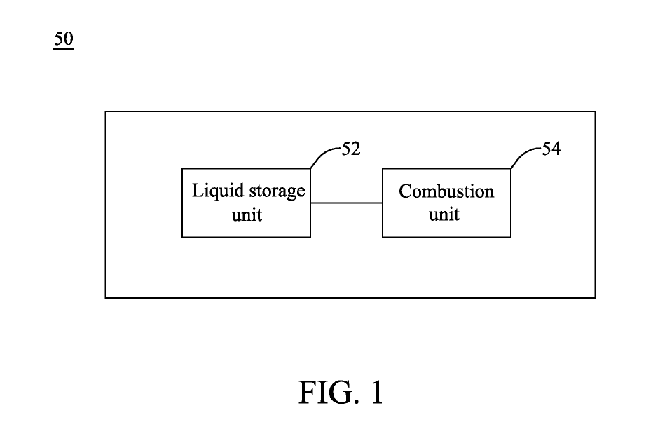

Referring now to FIG. 1, a schematic view of an embodiment of the steam-generating device in accordance with the present invention is shown.

In this embodiment, the steam-generating device 50 includes a liquid storage unit 52 and a combustion unit 54. The combustion unit 54 is connected with the liquid storage unit 52. The combustion unit 54 transfers a heat generated by burning a fuel to a liquid inside the liquid storage unit 52 so as to heat up the liquid in the liquid storage unit 52 and then generate a steam. Thus, the steam-generating device 50 generates the steam in a fuel combustion manner, to replace the conventional manner of generating the steam by an electric heat source.

In addition, the steam-generating device 50 in this embodiment can be arranged to pair any facility using the steam medium. In the following examples, two applications of the steam-generating device 50 are elucidated by accompanying drawings.

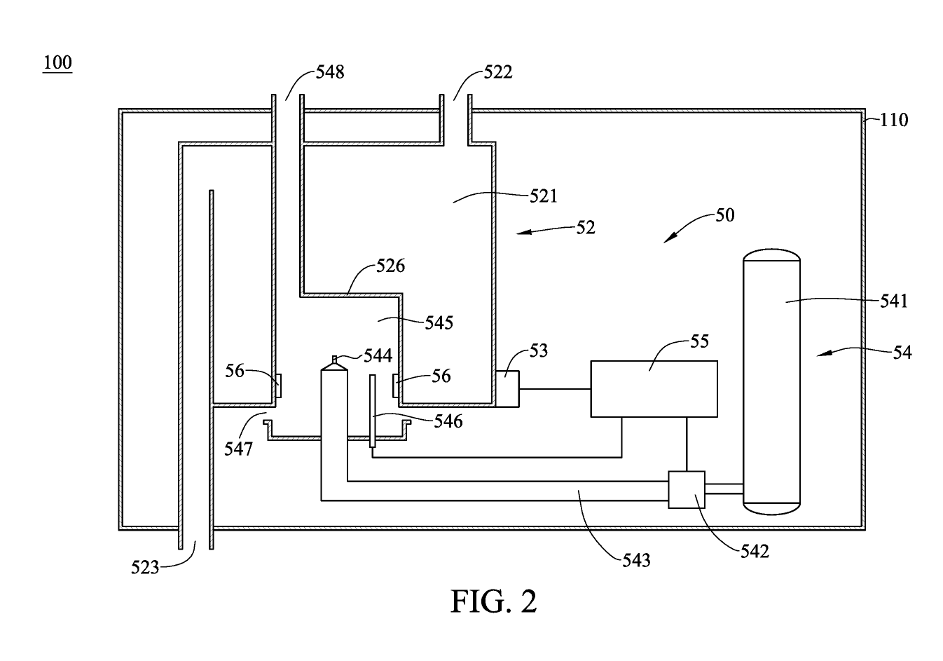

Referring now to FIG. 2, a schematic view of an embodiment of the steam-cleaning apparatus in accordance with the present invention is shown. It shall be noted firstly that FIG. 2 is prepared only for a concise explanation, and is not used to limit the steam-cleaning apparatus of the present invention.

In this embodiment, the steam-cleaning apparatus 100 includes a housing unit 110 and a steam-generating device 50. It shall be noted that, in this embodiment, the housing unit 110 shown in FIG. 2 is only a typical example of the present invention, not a unique embodiment of the present invention. In practice, the formation of the housing unit 110 can be varied according to the practical requirement of the steam-cleaning apparatus.

The steam-generating device 50 includes a liquid storage unit 52, a temperature-detecting unit 53, a combustion unit 54, a control unit 55 and at least one heat-conducting assembly 56 (two in this embodiment).

The liquid storage unit 52 located in the housing unit 110 includes a water storage chamber 521, a water inlet 522 and a steam outlet 523. The water inlet 522 is connected spatially with the water storage chamber 521, and the steam outlet 523 is connected spatially with the water storage chamber 521. Namely, the liquid storage unit 52 of this embodiment has two channels communicating spatially the atmosphere; one (the water inlet 522) for introducing the liquid to the water storage chamber 521, and another (the steam outlet 523) for outputting the steam.

It shall mention that, in this embodiment, the liquid storage unit 52 can adopt a water-supplying mechanism (such as a water pump and a water container) to, for example, apply the water pump to convey the liquid inside the water container into the water storage chamber 521 through the water inlet 522.

The combustion unit 54 connected with the liquid storage unit 52 includes a fuel supply unit 541, a valve assembly 542, a fuel-conveying pipe 543, a fuel nozzle 544, a combustion chamber 545, an ignition assembly 546, a first ventilation hole 547 and a second ventilation hole 548.

In this embodiment, the fuel supply unit 541 for containing the fuel can be a gas can in a cartridge form or in a mountain-climbing format. The fuel supply unit 541 connected spatially with the combustion chamber 545 is to provide the fuel to the combustion chamber 545. The valve assembly 542 connected with the fuel supply unit 541 is to control open/close of the fuel-conveying pipe 543. It shall be noted that, in this embodiment, the valve assembly 542 can be, but not limited to, an electric device or a mechanical switch for controlling open/close of the fuel supply unit 541. Also, the aforesaid valve assembly 542 is connected with the control unit 55, so that the control unit 55 can be used to regulate the open or close degree of the fuel supply unit 541. In addition, the temperature-detecting unit 53 connected with the combustion unit 54 is to detect if or not the fuel inside the combustion chamber 545 of the combustion unit 54 is burning. In this embodiment, the temperature-detecting unit 54 can be a light switch. Further, the temperature-detecting unit 54 is connected with control unit 55, and the ignition assembly 546 is connected with the control unit 55, such that the control unit 55 can be used to control the temperature-detecting unit 54, the ignition assembly 546 and the valve assembly 542, so as to determine the degree of combustion or to stop the combustion.

In practice, the fuel-conveying pipe 543 of this embodiment is to connect the combustion chamber 545 and the fuel supply unit 541. The fuel nozzle 544 is mounted to one end of the fuel-conveying pipe 543 that connects the combustion chamber 545. Upon such an arrangement, the fuel provided by the fuel supply unit 541 can be transmitted into the combustion chamber 545 via the fuel-conveying pipe 543 and the fuel nozzle 544, and the valve assembly 542 can be used to control the open/close of the fuel-conveying pipe 543. The ignition assembly 546 located inside the combustion chamber 544 is to ignite the fuel in the combustion chamber 545. In addition, a first ventilation hole 547 and a second ventilation hole 548 are provided to the combustion chamber 545 so as to increase the ventilation inside the combustion chamber 545, i.e. the airflow efficiency through the combustion chamber 545. It shall be explained that positions and number of the aforesaid ventilation holes are only unique examples from various embodiments of the present invention. Appropriate positions and number of the ventilation holes of the present invention shall be determined according to practical requirements.

In this embodiment, the combustion chamber 545 is located under the liquid storage unit 52. Practically, as shown in FIG. 2, at the bottom of the water storage chamber 521 in the liquid storage unit 52, a concave portion 526 is included to accommodate the combustion chamber 545. Thereupon, the combustion of the fuel can occur inside the concave portion 526, such that the heated area of the water storage chamber 521 can be increased, and the entire productivity of the steam of the steam-cleaning apparatus 100 can be enhanced.

In this embodiment, the heat-conducting assemblies 56 located inside the combustion chamber 545 of the combustion unit 54 can be a heat-conducting plate for improving the efficiency of heat transfer. It shall be explained that positions and number of the aforesaid heat-conducting assemblies are only unique examples from various embodiments of the present invention. Appropriate positions and number of the heat-conducting assemblies of the present invention shall be determined according to practical requirements.heat-conducting assembly.

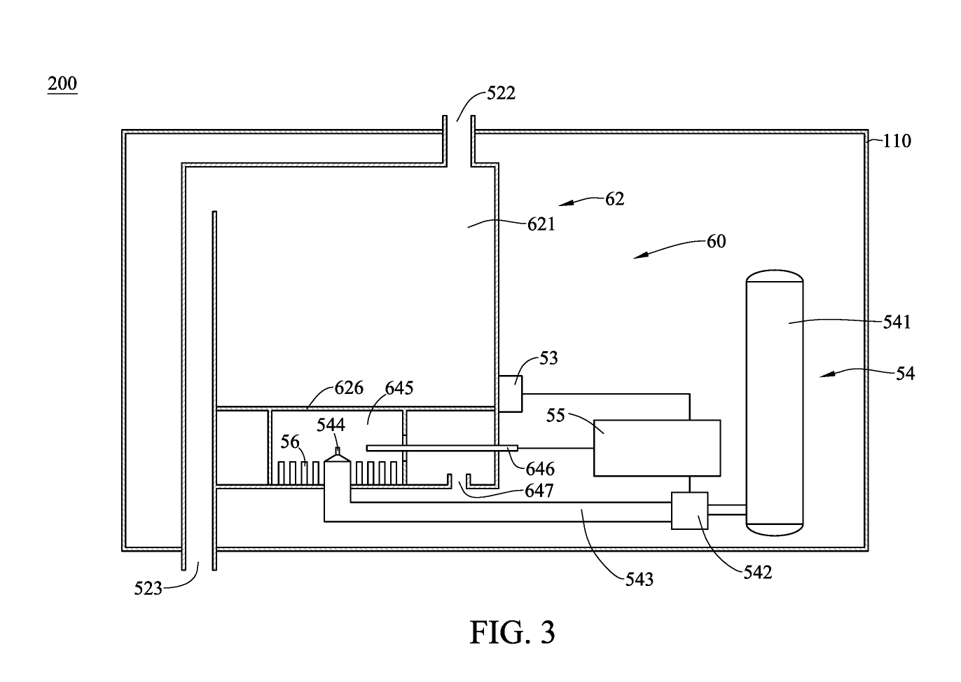

Referring now to FIG. 3, a schematic view of another embodiment of the steam-cleaning apparatus in accordance with the present invention is shown. It shall be explained that the steam-cleaning apparatus 200 of FIG. 3 is resembled to the steam-cleaning apparatus 100 of FIG. 2. Thus, similar elements having the same functions are labelled by the same number, and thus details thereabout would be omitted herein. In the following description upon this embodiment of FIG. 3, only different elements from the aforesaid embodiment of FIG. 2 is elucidated.

A difference between FIG. 3 and FIG. 2 is that, in this instant embodiment of the steam-generating device 60, the bottom of the water storage chamber 621 of the liquid storage unit 62 is embodied as a ring shape having an inner ring portion 626. The combustion chamber 645 is located within the inner ring portion 626. A ventilation hole 647 is furnished to a bottom of the combustion chamber 645. Part of the ignition assembly 646 is located inside the combustion chamber 645 and adjacent to the fuel nozzle 544. Namely, the combustion chamber 645 of this embodiment is located within the inner ring portion 626 so as to increase the heat-effected area of the water storage chamber 621.

In summary, in the steam-generating device and the steam-cleaning apparatus of the present invention, the steam-generating device provides a combustion way to produce the steams, such that the conventional electric heat source can be replaced. By providing the aforesaid steam-generating device to the steam-cleaning apparatus, thus no electric cable is needed anymore for the steam-cleaning apparatus. Namely, a wireless steam-cleaning apparatus is obtained.

Further, in the aforesaid steam-cleaning apparatus, the control unit is introduced to control the temperature-detecting unit, the ignition assembly and the valve assembly, so that the combustion state is controllable. Also, through the valve assembly, the open/close state of the fuel-conveying pipe can thus be controlled. In addition, by having the water storage chamber to be shaped as a concave portion or a ring to accommodate the combustion chamber, then the heat-effected area of the water storage chamber can be increased, and also the entire productivity of the steam of the steam-cleaning apparatus can be enhanced.

In addition, the combustion chamber of the present invention can introduce plural ventilation holes to enhance the ventilation, such that the airflow efficiency through the combustion chamber can be increased. Furthermore, the number of internal heat-conducting assemblies inside the combustion chamber of the present invention can because increased per requirements, so that the efficiency of the heat transfer thereof can be substantially ensured.

While the present invention has been particularly shown and described with reference to a preferred embodiment, it will be understood by those skilled in the art that various changes in form and detail may be without departing from the spirit and scope of the present invention.

What is claimed is:

1. A steam-cleaning apparatus, comprising:
a housing unit; and
a steam-generating device, including:
a liquid storage unit, located inside the housing unit, further including a water storage chamber, a water inlet and a steam outlet, the water inlet being connected spatially with the water storage chamber, the steam outlet being connected spatially with the water storage chamber, the water inlet being to introduce a liquid into the water storage chamber; and
a combustion unit, located in the housing unit, connected with the liquid storage unit;
wherein the combustion unit transfers a heat generated by burning a fuel to the liquid inside the liquid storage unit so as to heat up the liquid in the liquid storage unit and then generate a steam outputted by the steam outlet.

2. The steam-cleaning apparatus of claim 1, wherein the combustion unit includes a combustion chamber, a fuel supply unit and an ignition assembly, the fuel supply unit connected with the combustion chamber, the ignition assembly being located in the combustion chamber, the combustion chamber being located under the liquid storage unit, the fuel supply unit being to provide the fuel to the combustion chamber, the ignition assembly being to ignite the fuel.

3. The steam-cleaning apparatus of claim 2, wherein the combustion unit further includes a valve assembly and a fuel-conveying pipe, the fuel-conveying pipe connecting the combustion chamber and the fuel supply unit, the valve assembly being connected with the fuel supply unit, the valve assembly being to control open/close of the fuel-conveying pipe.

4. The steam-cleaning apparatus of claim 2, wherein a bottom of the water storage chamber has a concave portion, the combustion chamber being located in the concave portion.

5. The steam-cleaning apparatus of claim 2, wherein a bottom of the water storage chamber has an inner ring portion, the combustion chamber being located within the inner ring portion.

6. The steam-cleaning apparatus of claim 2, further including at least one heat-conducting assembly in the combustion unit.

7. The steam-cleaning apparatus of claim 1, further including a temperature-detecting unit connected with the combustion unit for detecting if or not the fuel is burned in the combustion unit.

8. A steam-generating device, comprising:
a liquid storage unit; and
a combustion unit, connected with the liquid storage unit;
wherein the combustion unit transfers a heat generated by burning a fuel to the liquid inside the liquid storage unit so as to heat up the liquid in the liquid storage unit and then generate a steam.

9. The steam-generating device of claim 8, wherein the combustion unit includes a combustion chamber, a fuel supply unit and an ignition assembly, the fuel supply unit connected with the combustion chamber, the ignition assembly being located in the combustion chamber, the combustion chamber being located under the liquid storage unit, the fuel supply unit being to provide the fuel to the combustion chamber, the ignition assembly being to ignite the fuel.

10. The steam-generating device of claim 8, wherein the fuel supply unit is a gas can.
